(19) United States
(12) Patent Application Publication
(10) Pub. No.: US 2010/0056250 A1
(43) Pub. Date: Mar. 4, 2010

(54) GAMING MACHINE WITH VARIETY ACCORDING TO PLAYER'S SKILL AND CONTROL METHOD THEREOF

(75) Inventor: Kazumasa YOSHIZAWA, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp., Tokyo (JP)

(21) Appl. No.: 12/511,632

(22) Filed: Jul. 29, 2009

Related U.S. Application Data
(60) Provisional application No. 61/094,238, filed on Sep. 4, 2008.

(51) Int. Cl. A63F 9/24; A63F 13/00

(52) U.S. Cl. 463/20; 463/30; 463/25

(57) ABSTRACT

In a gaming machine, a unit game in which symbols having been arranged are rearranged is displayed on a display. Then, a special game is displayed on the display in case where a predetermined condition has been met. In addition, in the slot machine, since a payout and effects at an execution of a special game can be varied according to a player's input operation, different results can be brought according to a variety of abilities with respect to the player's input operation.

### CROSS-REFERENCE TO RELATED APPLICATION

This application is based upon and claims the benefit of U.S. Provisional Patent Application Ser. No. 61/094,238, filed on Sep. 4, 2008; the entire contents of which are incorporated herein by reference for all purposes.

### BACKGROUND OF THE INVENTION

1. Field of the Invention

The present invention relates to a gaming machine for playing games using medals and so on, and a control method of a gaming machine.

2. Description of Related Art

A player can play a game provided at a gaming machine by betting a wager amount such as coins and credits at the gaming machine in a facility in which gaming machines such as slot machines are installed, as described in U.S. Pat. No. 5,820,459, U.S. Pat. No. 6,695,697, United States Patent Application Laid-Open No. 2003/0069073, European Patent Application Laid-Open No. 1192975, U.S. Pat. No. 6,254,483, U.S. Pat. No. 5,611,730, U.S. Pat. No. 5,639,088, U.S. Pat. No. 6,257,981, U.S. Pat. No. 6,234,896, U.S. Pat. No. 6,001,016, U.S. Pat. No. 6,273,820, U.S. Pat. No. 6,224,482, U.S. Pat. No. 4,669,731, U.S. Pat. No. 6,244,957, U.S. Pat. No. 5,910,048, U.S. Pat. No. 5,695,402, U.S. Pat. No. 6,003,013, U.S. Pat. No. 4,283,709, European Patent Application Laid-Open No. 0631798, German Patent Application Laid-Open No. 4137010, United Kingdom Patent Application Laid-Open No. 2326830, German Patent Application Laid-Open No. 3712841, U.S. Pat. No. 4,964,638, U.S. Pat. No. 6,089,980, U.S. Pat. No. 5,280,909, U.S. Pat. No. 5,702,303, U.S. Pat. No. 6,270,409, U.S. Pat. No. 5,770,533, U.S. Pat. No. 5,836,817, U.S. Pat. No. 6,932,704, U.S. Pat. No. 6,932,707, U.S. Pat. No. 4,837,728, European Patent Application Laid-Open No. 1302914, U.S. Pat. No. 4,624,459, U.S. Pat. No. 5,564,700, International Patent Application Laid-Open No. 03/083795, German Patent Application Laid-Open No. 3242890, European Patent Application Laid-Open No. 0840264, German Patent Application Laid-Open No. 10049444, International Patent Application Laid-Open No. 04/095383, European Patent Application Laid-Open No. 1544811, U.S. Pat. No. 5,890,963, European Patent Application Laid-Open No. 1477947, European Patent Application Laid-Open No. 1351180 and Japanese Patent Application Laid-Open No. 5-205233.

For example, the slot machine executes a slot game, in which symbols having been arranged on a display are rearranged, after each player's operation of betting a wager amount and then pressing a start switch. And then, if the predetermined number of scatter symbols have been included in the rearranges symbols on the display or the predetermined winning combination has been achieved on a payline, an award is provided according to its contents.

Further, in the gaming machine represented by an above-mentioned slot machine, a special game will be executed in case where the predetermined condition has been met. The special game is generally a free game(s) without a need of betting a wager amount and also called as a feature game(s). In the special game as represented by a free game, there is a chance to get more awards.

However, an award previously determined at random is provided to a player in a special game, so that an award may not be varied according to a player's ability or skill. Since the same results will be brought by any player's game play, it is fair but not varied due to a player's ability or skill.

### SUMMARY OF THE INVENTION

An aspect of the present invention provides a gaming machine executing a unit game and a special game, the gaming machine includes: a display for displaying, upon establishment of a predetermined condition in the unit game, the special game in which a first object is operated so as to contact with a second object in order to move the second object; a sensor for detecting a player's input operation onto the display to operate the first object; and a controller programmed to execute following processing (A) and (B): (A) a process for determining, in the special game, velocity and a moving direction of the first object on the display based on an input distance and an input duration time taken from the input operation detected by the sensor, and (B) a process for determining an award to be provided to the player based on a moved result of the second object moved due to a contact with the first object having been moved according to the determined velocity and the determined moving direction.

Another aspect of the present invention provides a gaming machine executing a unit game and a special game, the gaming machine includes: a display for displaying, upon establishment of a predetermined condition in the unit game, the special game in which a first object is operated so as to contact with a second object in order to drop the second object into a payout spot; a sensor for detecting a player's input operation onto the display to operate the first object; and a controller programmed to execute following processing (A) and (B) : (A) a process for determining, in the special game, velocity and a moving direction of the first object on the display based on an input distance and an input duration time taken from the input operation detected by the sensor, and (B) a process for determining an award to be provided to the player based on a result of dropping into the payout spot of the second object moved due to a contact with the first object having been moved according to the determined velocity and the determined moving direction.

Another aspect of the present invention provides a gaming machine executing a unit game and a special game, the gaming machine includes: a display for displaying, upon establishment of a predetermined condition in the unit game, the special game in which a first object is operated so as to contact with a second object in order to drop the second object into payout spots including a multi spot to which a different payout rate is set; a sensor for detecting a player's input operation onto the display to operate the first object; and a controller programmed to execute following processing (A) and (B): (A) a process for determining, in the special game, velocity and a moving direction of the first object on the display based on an input distance and an input duration time taken from the input operation detected by the sensor, and (B) a process for determining an award to be provided to the player based on a result of dropping into the payout spots of the second object moved due to a contact with the first object having been moved according to the determined velocity and the determined moving direction.

Another aspect of the present invention provides a control method of a gaming machine executing a unit game and a special game, the gaming machine includes a display for displaying, upon establishment of a predetermined condition in a unit game, a special game in which a first object is operated so as to contact with a second object in order to move the second object, and a sensor for detecting a player's input operation onto the display to operate the first object. The method includes: executing a process for determining, in the special game, velocity and a moving direction of the first object on the display based on an input distance and an input duration time taken from the input operation detected by the sensor, and executing a process for determining an award to be provided to the player based on a moved result of the second object moved due to a contact with the first object having been moved according to the determined velocity and the determined moving direction.

### BRIEF DESCRIPTION OF THE DRAWINGS

FIG. 1A is a flow chart showing a general scheme of a slot machine in a first embodiment which is an example of a gaming machine according to the present invention and a playing method thereof;

FIG. 1B is a flow chart showing a general scheme of a slot machine in a second embodiment which is an example of a gaming machine according to the present invention and a playing method thereof;

FIG. 1C is a flow chart showing a general scheme of a slot machine in a third embodiment which is an example of a gaming machine according to the present invention and a playing method thereof;

FIG. 2 is an explanatory diagram showing a screen example displayed on a display of the slot machine in the first embodiment according to the present invention;

FIG. 3 is an explanatory diagram showing segmented areas arranged in a matrix and provided on the display of the slot machine in the first embodiment according to the present invention;

FIG. 4 is a perspective view of the slot machine in the first embodiment according to the present invention;

FIG. 5 is a block diagram showing a control circuit of the slot machine in the first embodiment according to the present invention;

FIG. 6 is an explanatory diagram (I) showing a screen example of a special game executed on the display of the slot machine in the first embodiment according to the present invention;

FIG. 7 is an explanatory diagram (II) showing a screen example of a special game executed on the display of the slot machine in the first embodiment according to the present invention;

FIG. 8 is an explanatory diagram (III) showing a screen example of a special game executed on the display of the slot machine in the first embodiment according to the present invention;

FIG. 9 is an explanatory diagram (IV) showing a screen example of a special game executed on the display of the slot machine in the first embodiment according to the present invention;

FIG. 10 is a flow chart showing procedures of a slot game processing in the slot machine in the first embodiment according to the present invention;

FIG. 11 is a flow chart showing procedures of a special game execution processing in the slot machine in the first embodiment according to the present invention;

FIG. 12 is an explanatory diagram showing a screen example of a slot game executed on the display of the slot machine in the first embodiment according to the present invention;

FIG. 13 is an explanatory diagram showing a screen example of a slot game executed on the display of the slot machine in the first embodiment according to the present invention;

FIG. 14 is an explanatory diagram (I) showing a screen example of a special game executed on the display of the slot machine in the second embodiment according to the present invention;

FIG. 15 is an explanatory diagram (II) showing a screen example of a special game executed on the display of the slot machine in the second embodiment according to the present invention;

FIG. 16 is an explanatory diagram (III) showing a screen example of a special game executed on the display of the slot machine in the second embodiment according to the present invention;

FIG. 17 is an explanatory diagram (IV) showing a screen example of a special game executed on the display of the slot machine in the second embodiment according to the present invention;

FIG. 18 is a flow chart showing procedures of a special game execution processing in the slot machine in the second embodiment according to the present invention;

FIG. 19 is an explanatory diagram (I) showing a screen example of a special game executed on the display of the slot machine in the third embodiment according to the present invention;

FIG. 20 is an explanatory diagram (II) showing a screen example of a special game executed on the display of the slot machine in the third embodiment according to the present invention;

FIG. 21 is an explanatory diagram (III) showing a screen example of a special game executed on the display of the slot machine in the third embodiment according to the present invention;

FIG. 22 is an explanatory diagram (IV) showing a screen example of a special game executed on the display of the slot machine in the third embodiment according to the present invention;

FIG. 23 is a flow chart showing procedures of a special game execution processing in the slot machine in the third embodiment according to the present invention;

FIG. 24 is an explanatory diagram showing a screen example of a special game executed on the display of the slot machine in the fourth embodiment according to the present invention; and

FIG. 25 is a graph used for determining velocity of a first object in the slot machine in the fourth embodiment according to the present invention.

### DETAILED DESCRIPTION OF THE EMBODIMENT

### First Embodiment

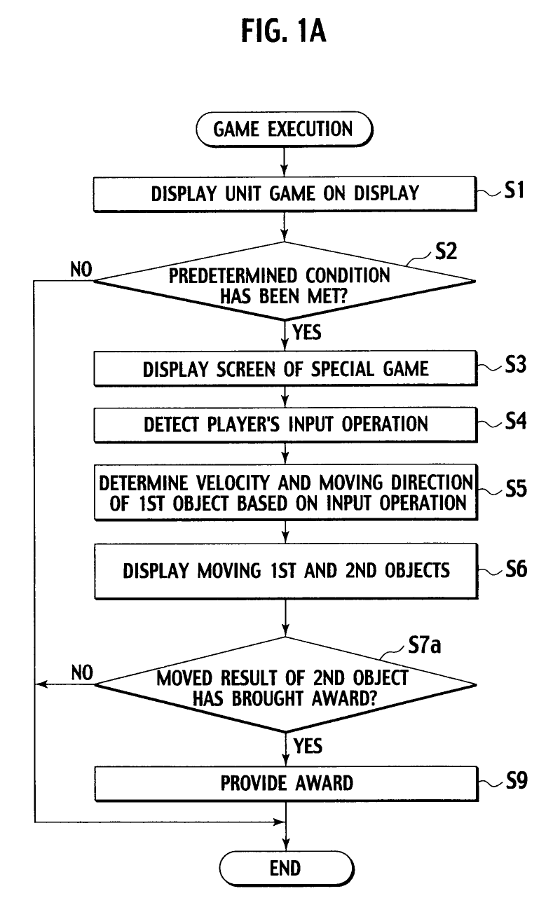

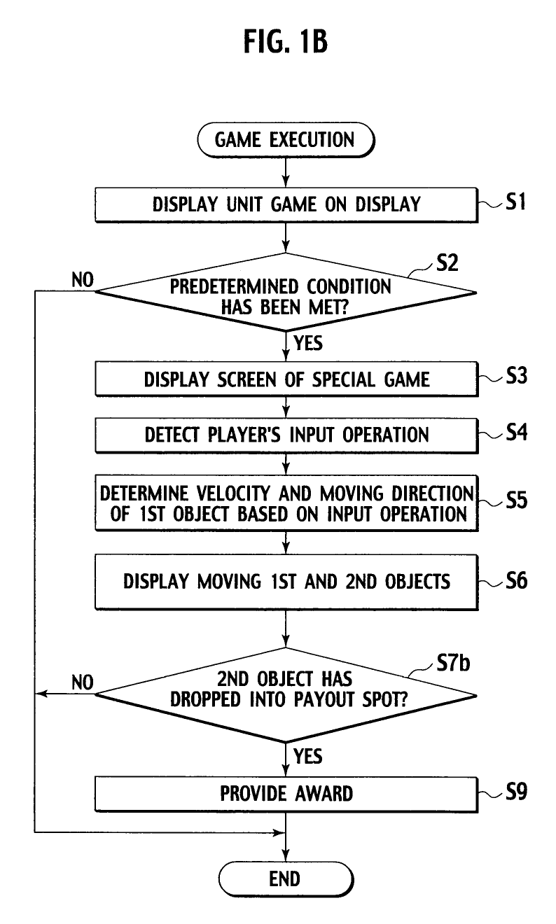

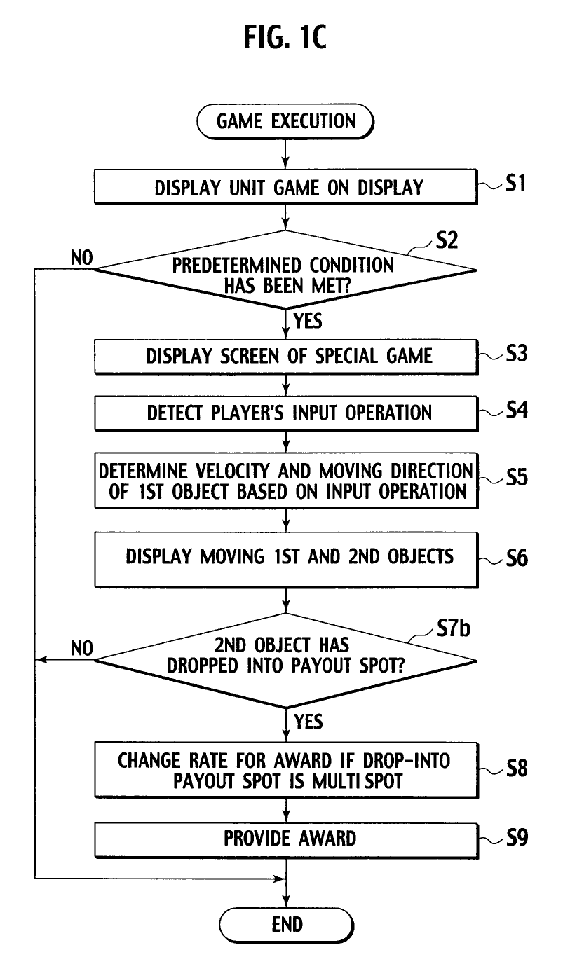

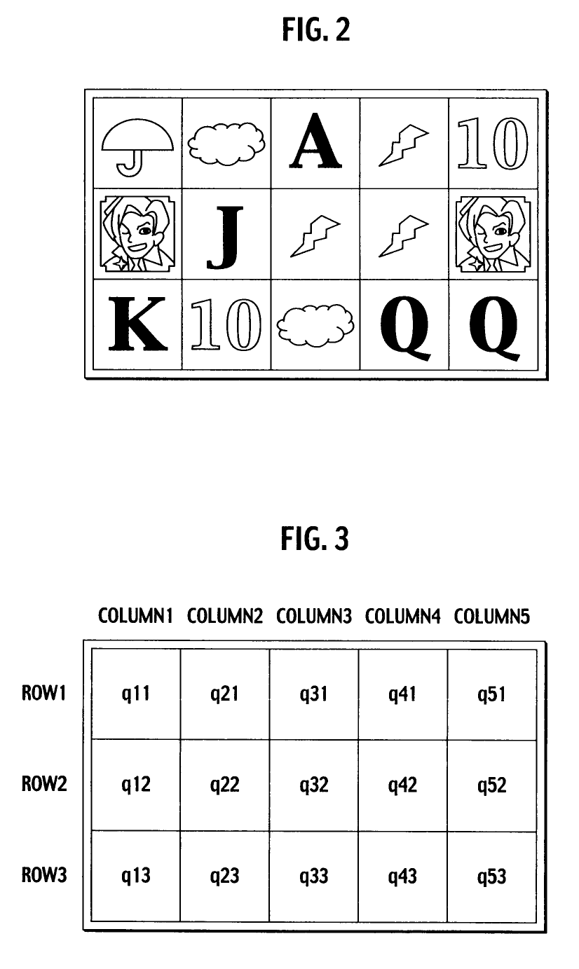

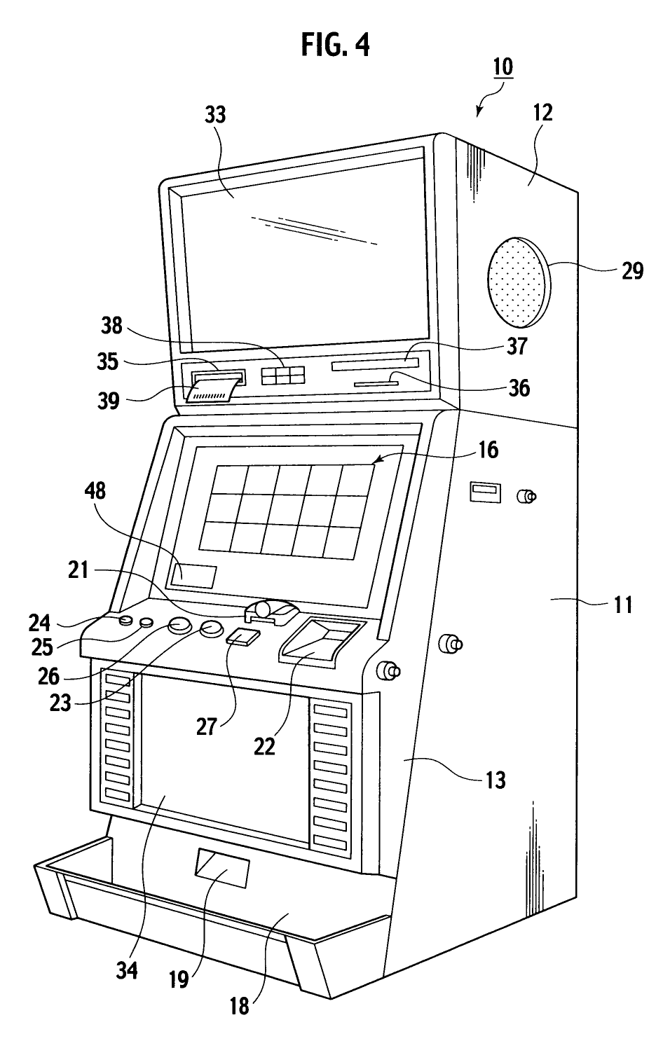

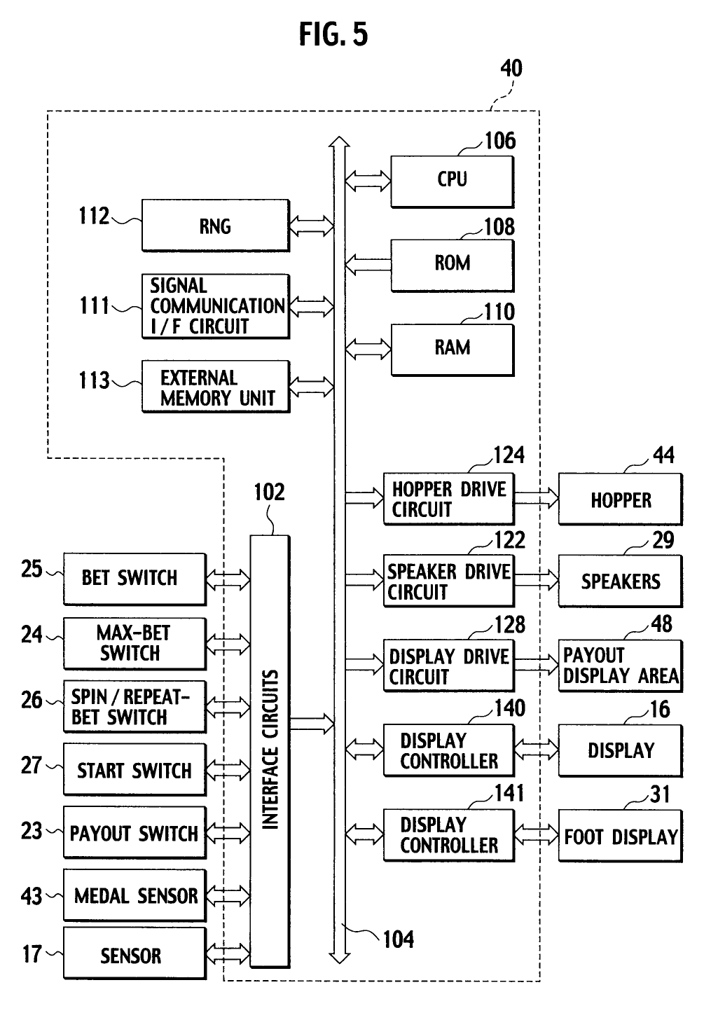

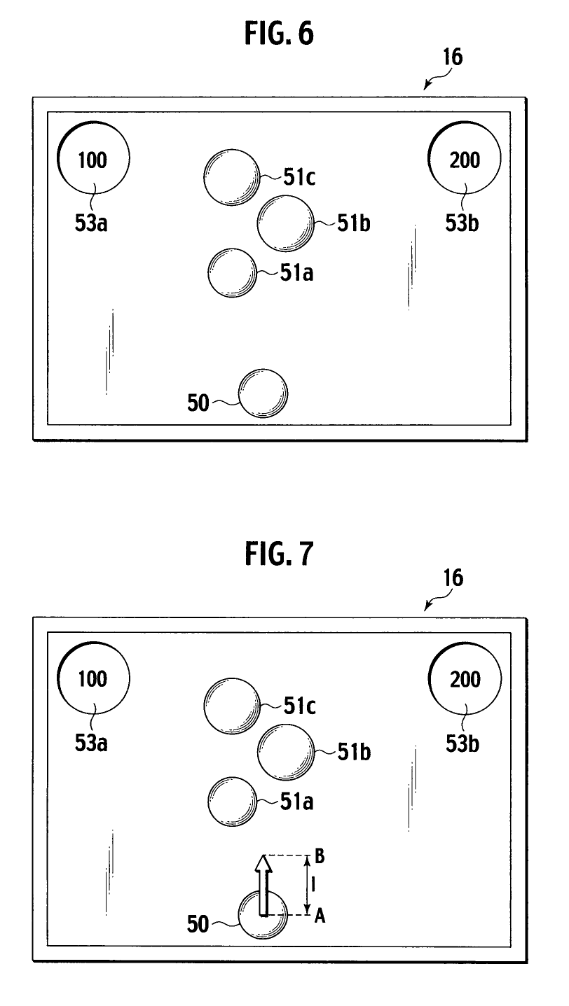

FIG. 1A is a flow chart showing a general scheme of a playing method of a gaming machine in a first embodiment according to the present invention. FIG. 2 is an explanatory diagram showing a screen example displayed on a display of a slot machine as one example of the gaming machine in the first embodiment according to the present invention. FIG. 3 is an explanatory diagram showing segmented areas arranged in a matrix and provided on the display of the slot machine in the first embodiment according to the present invention. FIG. 4 is a perspective view of the slot machine in the first embodiment according to the present invention. FIG. 5 is a block diagram showing a control circuit of the slot machine in the first embodiment according to the present invention. FIGS. 6 to 9 are explanatory diagrams each showing a screen example sown as a special game of the gaming machine in the first embodiment according to the present invention.

A display 16 is provided on a front face of a cabinet 11 of a slot machine 10 shown in FIG. 4. The display 16 includes fifteen segmented areas q11 to q53 as shown in FIG. 3. The segmented areas q11 to q53 are arranged in a matrix composed of first to fifth columns and first to third rows.

Symbols having been arranged as shown in FIG. 2 in the above-mentioned segmented areas q11 to q53 shown in FIG. 3 are rearranged in each execution of unit games in the slot machine 10 according to one example of the present invention shown in FIG. 4. For example, a unit game can be executed by a scrolling display and a stopped display in the segmented areas q11 to q53 on the display 16 by displaying on a liquid crystal panel.

Symbols displayed on the display 16 include nine kinds of symbols such as “A (Ace of cards)”, “K (King of cards)”, “Q (Queen of cards)”, “J (Jack of cards)”, “10 (Ten of cards)” “Umbrella”, “Lighting”, “Cloud” and “Special (male face).

And then, an award of credits is determined based on a rule predetermined in a payout table to provide a payout of the credits for the determined award after symbols have been rearranged in the segmented areas q11 to q53 in a unit game. Subsequently, symbols q11 to q53 will be rearranged due to a start of a next unit game.

As shown in FIG. 1A, the slot machine 10 according to the one example of the present invention displays a unit game on the display 16 shown in FIG. 4, in which symbols having been arranged are rearranged as described above (step S1).

This unit game can be made playable through a player's bet of a wager amount. Specifically, a bet of a wager amount can be placed by a player's insertion of coins or medals, which are cashable credits capable of being exchanged into cash, into the slot machine 10. In addition, a bet of a wager amount also can be placed through a player's operation to appropriate restricted credits, which are electronically stored in the slot machine 10 and continuously usable as a wager amount until being exchanged into cash, to a wager amount as much as specified by the player.

Note that a unit of a wager amount capable of being bet with the above-mentioned cashable or restricted credits will be called as “credit” in the following descriptions. For example, “one credit” will be bet as a wager amount in case where a player has inserted one medal or coin into the slot machine 10 for the wager amount. In addition, for example, “two credits” will be bet as a wager amount in case where two restricted credits have been appropriated to the wager amount through a player's operation of the slot machine 10.

Next, as shown in FIG. 1A, the slot machine 10 determines whether or not the predetermined condition for a special game execution has been met (step S2). For example, a special game is also called as a free game(s) (feature game(s)), for example. For example, whether or not the predetermined condition has been met can be determined based on whether or not a condition establishment sortition was hit, which is executed based on a random number generated by an RNG 112 shown in FIG. 5 at each of displaying a unit game on the display.

Then, as shown in FIG. 1A, if the predetermined condition has not been met (NO in step S2), the slot machine 10 stops a series of processes and displays a unit game on the display again in step S1.

On the other hand, if the predetermined condition has been met (YES in step S2), the slot machine 10 displays a special game screen as shown in FIG. 6 on the display 16 (step S3).

Subsequently, the slot machine 10 detects a player's input operation by a sensor 17 (see FIG. 59 such as a touchpad.

For example, the sensor 17 for detecting a player's input operation can be a touchscreen installed on the display 16. Since a player's touching operation onto a screen display on the display 16 such as an arrow shown in FIG. 7 is directly detected as an input operation in case where a device for detecting a player's input operation is a touchscreen, a player can viscerally operate a first object such as a coin or a ball displayed on the display 16.

Next, the slot machine 10 determines velocity and a moving direction of the first object on the display 16 based on an input distance and an input duration time determined from the detected player's input operation (step S5).

For example, if the player's input operation as the arrow shown in FIG. 7 has been detected, input velocity l/t is calculated from the input distance l from an input start point A to an input end point B and the input duration time t spent for the input operation and the moving speed of the first object 50 on the display 16 is determined according to the calculated input velocity. In addition, the moving direction of the first object 50 on the display 16 is determined according to the direction of the arrow connecting between the input start point A and the input end point B.

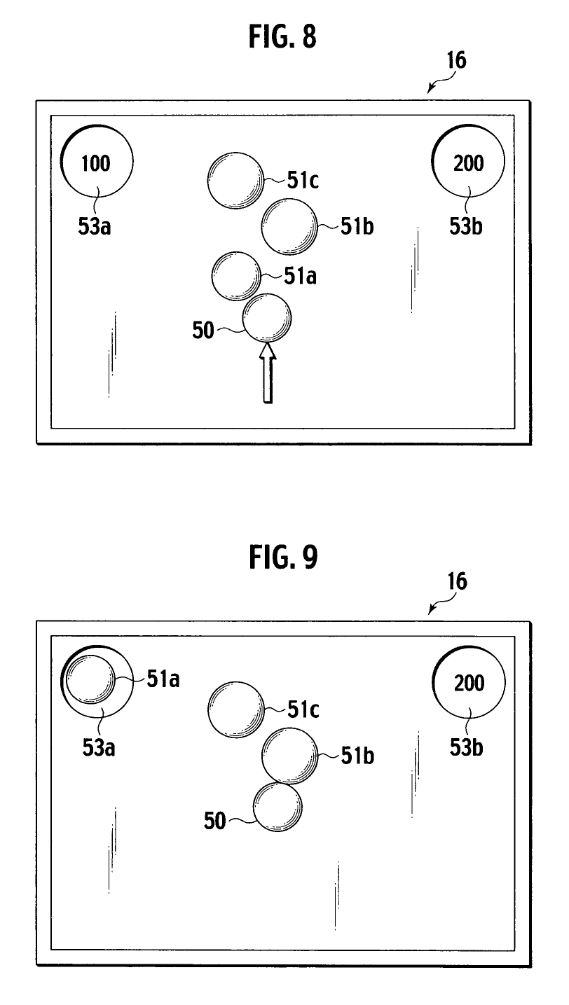

And then, as shown in FIG. 8, a moving presentation of the first object 50, which is being moved according to the velocity and the moving direction determined in step S5, is displayed on the display 16 (step S6). Further, as shown in FIG. 9, each moving presentation of payout objects 51a to 51c (corresponds to second objects in the claims) moved due to contacts with the first object 50 is displayed on the display 16 (step S6).

Here, it is determined whether or not moved results of the second objects 51a to 51c have brought a result to provide an award to a player (step S7a). For example, whether or not to bring a result to provide an award can be determined according to whether or not any of the moved results of the second objects 51a to 51c have brought an existence within any of payout spots 53a and 53b set for an award to a player.

If any of the moved results of the second objects 51a to 51c have not brought a result to provide an award to a player (NO in step S7a), the slot machine 10 terminates the series of processes of the special game. On the other hand, if any of the moved results of the second objects 51a to 51c have brought a result to provide an award to a player, for example, if any of the moved results of the second objects 51a to 51c have brought an existence within any of the payout spots 53a and 53b set for an award to a player (YES in step S7a), an award is provided to a player (step S9).

As a result of the above-mentioned processes, in the slot machine 10 according to the first embodiment, the first object 50 is moved based on a player's input operation and whether to provide an award to a player is determined by judging the moved results of the second objects 51a to 51c moved due to contacts with the first object 50. In other words, the slot machine 10 according to the first embodiment can determine an award to be provided to a player in a special game based on a player's input operation. Therefore, a payout and effects can be varied according to player's skill and judgment and an award can be varied according to a player's ability or skill.

Next, the slot machine in the first embodiment according to the present invention will be explained in detail. As shown in FIG. 4, the slot machine 10 in the present embodiment includes the cabinet 11, a top box 12 provided on top of the cabinet 11 and a main door 13 provided at a front face of the cabinet 11. The display 16 is disposed on the front of the main door 13. The display 16 can be a touchscreen that has a configuration with an LCD panel capable of display transmissively and a sensor installed thereon for detecting a player's input operation. The display 16 includes the fifteen segmented areas q11 to q53 as shown in FIG. 3 that are arranged in a matrix composed of the first to fifth columns and the first to third rows.

Any one of nine kinds of symbols such as “A (Ace of cards)”, “K (King of cards)”, “Q (Queen of cards)”, “J (Jack of cards)”, “10 (Ten of cards)” “Umbrella”, “Lighting”, “Cloud” and “Special (male face) will be displayed in each of the segmented areas q11 to q53.

In the slot machine 10 of the present embodiment, one slot game (unit game) is executed by rearranging symbols in the segmented areas q11 to q53 as shown in FIG. 2. Although slot games can be generally played by betting a wager amount using gaming media, slot games can be played without betting a wager amount during the special game (the free games) executed after an establishment of the predetermined condition.

During the special game, for example, the first object 50, the second objects 51a to 51c and the payout spots 53a and 53b are displayed on the display 16 as shown in FIGS. 6 to 9.

Note that, in the present embodiment, although medals are used as gaming media at slot game executions (however, except for the free games), media for slot games are not limited to medals and, for example, medals, tokens, electronic money or other equivalent electronic value information (credits) may be also used.

Various input buttons 23 for accepting player's operations relating to game plays, a coin acceptor 21 for accepting coins and a bill validator 22 for accepting valid bills are disposed beneath the display 16. Note that the bill validator 22 may be configured to be able to read a bar-coded ticket 39.

Various operational switches are provided near the medal insertion slot 21 and the bill validator 22. A payout switch 23, a max-bet switch 24, a bet switch 25, a spin/repeat-bet switch 26 and a start switch 27 are provided as the operational switches.

The bet switch 25 is a switch for determining a credit amount to be bet on a slot game executed on the display 16 and one credit corresponding to one medal is bet each pressing of the bet switch 25 as explained later.

The spin/repeat-bet switch 26 is a switch for betting a credit amount again without changing a bet amount had been bet on the last slot game using the above-mentioned bet switch 25.

The start switch 27 is a switch for starting a slot game after betting a desired credit amount. A slot game is started on the display 16 due to the start switch 27 being pressed after a credit bet by medals being inserted into the medal insertion slot 21 or by the bet switch 25 being pressed.

The payout switch 23 is a switch for paying out medals being inserted. The medals to be paid out will be discharged from a medal payout opening 19 opened at the front lower of the main door 13 and pooled on a medal tray 18.

The max-bet switch 24 is a switch for betting a maximum credit amount (e.g. equivalent to thirty medals) capable of being bet on one slot game by a one-time operation.

A foot display 34 is disposed on the lower front of the main door 13 to display predetermined image screens based on image display control data included in a game software being executed.

An upper display 33 is disposed on the front of the top box 12. The upper display 33 has a liquid crystal panel to display the payout table or the like.

In addition, speakers 29 are provided on the top box 12. A ticket printer 35, a card reader 36, a data display 37 and a keypad 38 are disposed beneath the upper display 33. The ticket printer 35 prints a bar-code, into which data, such as a credit amount, time and date and an identification number of the slot machine 10 are encoded, on a ticket and outputs it as a bar-code ticket 39.

A player can make the bar-code ticket 39 read by another slot machine to use it as a wager amount for playing a slot game at the other slot machine and can exchange the bar-code ticket 39 into bills and so on at a predetermined site in an amusement facility (e.g. a cashier in a casino).

A smart card can be inserted into the card reader 36 and the card reader 36 reads out data from the inserted smart card and writes data onto the smart card. A smart card is a card carried by a player and stores identification data of the player, history data of the player's game plays and so on.

The smart card may be able to store data corresponding to coins, bills ore credits. In addition, a magnetic stripe card may be employed instead of the smart card. The data display 37 is composed of a fluorescence display or the like to display data read out by the card reader 36, data input via the keypad 38 by a player or the like.

Alternatively, a card employing a RFID system and can be read-out and written-into data contactlessly. The keypad 38 can accept commands and data relating to ticket issuance or the like.

FIG. 5 is a block diagram showing control circuit of the slot machine according to the present embodiment. A machine controller 40 shown in the diagram is a microcomputer and includes interface circuits 102, an I/O bus 104, a CPU 106, the ROM 108, a RAM 110, a signal communication I/F circuit 111, the RNG 112, the external memory unit 113, a speaker drive circuit 122, a hopper drive circuit 124, a display drive circuit 128 and display controllers 140 and 141.

The interface circuits 102 are connected to the I/O bus 104 and the I/O bus 104 transmits data signals and address signals with the CPU 106.

The start switch 27 is connected to the interface circuits 102. A start command output from the start switch 27 is transmitted to the CPU 106 via the I/O bus 104 after being converted into a predetermined signal by the interface circuits 102.

Furthermore, the bet switch 25, the max-bet switch 24, the spin/repeat-bet switch 26 and the payout switch 23 are connected to the interface circuits 102. Each switching signal output from the switches 25, 24, 26 and 23 is transmitted to the CPU 106 via the I/O bus 104 after being converted into a predetermined signal by the interface circuits 102.

In addition, a medal sensor 43 and the sensor 17 are connected to the interface circuits 102. The medal sensor 43 is a sensor for detecting a medal(s) had been inserted into the medal insertion slot 21 and disposed inside a medal insertion point of the medal insertion slot 21. The sensor 17 is a sensor for detecting a player's input operation and provided with being embedded in the display 16. A detection signal output from the medal sensor 43 or the sensor 17 is transmitted to the CPU 106 via the I/O bus 104 after being converted into a predetermined signal by the interface circuits 102.

The ROM 108 for storing system programs and the RAM 110 for storing various data are connected to the I/O bus 104. The RAM 110 includes areas for storing a variety of information and for managing flags or the like.

The ROM 108 stores the payout table. The payout table contains correspondence relations between conditions for providing a payout and credit payout amounts for establishments of the conditions. The conditions for providing a payout are defined based on symbol combination rearranged in the segmented areas q11 to q53. The rearranged symbol combinations defined as eligibles for providing a payout can be defined based on the number of scatter symbols rearranged in a slot game or based on patterns of winning combinations achieved on a payline(s) set on the segmented areas q11 to q53. In a slot game of the present embodiment, the CPU 106 determines whether or not to provide a payout (to payout credits) and a credit payout amount (a credit amount to be paid out) based on the payout table and symbols stopped in the segmented areas q11 to q53.

The CPU 106 is triggered by the start switch 27 receiving a game start operation and then reads out the game execution programs from the ROM 108 to execute a slot game.

Specifically, the game execution programs are programmed to execute a slot game, in which symbols are displayed with being changed consecutively in the segmented areas q11 to q53 and then stopped and a payout credit amount is provided based on the payout table stored in the ROM 108 in case where the stopped symbols has achieved combination eligible for providing a payout.

Further, the RNG 112, the signal communication I/F circuit 111, the external memory unit 113, the display controllers 140 and 141, the hopper drive circuit 124, the speaker drive circuit 122 and the display drive circuit 128 are connected to the I/O bus 104.

The signal communication I/F circuit 111 is connected to a hall server or the like to transmit history data of game plays executed at the slot machine 10 or the like to the hall server. In addition, it receives a variety of data transmitted from the hall server.

The RNG 112 generates random numbers for determining whether or not to bring a winning combination or a jackpot in a slot game executed on the display 16.

The external memory unit 113 stores relations between the moved results of the second objects 51a to 51c and awards to be provided to a player with respect to a game executed as the special game after the establishment of the predetermined condition.

In addition, the external memory unit 113 stores a plurality of arrangement patterns for determining arrangements of the first object 50, the second objects 51a to 51c and the payout spots 53a and 53b on the display 16 in the special game.

In addition, the external memory unit 113 stores a plurality of movement patterns to be selected based on a player's input operation for determining velocity and a moving direction of the first object 50.

The display drive circuit 128 controls displaying a payout amount in a payout amount segmented area 48 provided at the lower-left area on the display 16.

The speaker drive circuit 122 outputs sound data to the speakers 29. Specifically, the CPU 106 reads out the sound data stored in the ROM 108 and transmits the sound data to the speaker drive circuit 122 via the I/O bus 104. As a result, predetermined sound effects are output from the speakers 29.

The hopper drive circuit 124 outputs a payout command to the hopper 44 when a payout is to be awarded. Specifically, the CPU 106 outputs a drive command to the hopper drive circuit 124 via the I/O bus 104 when receiving the payout command from the payout switch 23. As a result, the hopper 44 pays out medals equivalent to current credits stored in a prescribed memory area in the RAM 110.

On receiving an image display command output from the CPU 106, the display controller 140 generates a drive command for driving the display 16 based on the image display command and then outputs the generated drive command to the display 16.

In addition, the display controller 140 executes a display process to display the first object 50, the second objects 51a to 51c and the payout spots 53a and 53b on the display 16 during the special game as shown in FIGS. 6 to 9. Specifically, the CPU 106 generates an image display command for displaying images as shown in FIGS. 6 to 9 and outputs the image display command to the display controller 140 via the I/O bus 104 during the special game. On receiving the image display command output from the CPU 106, the display controller 140 generates a drive command for driving the display 16 based on the image display command and then outputs the generated drive command to the display 16. As a result, the images as shown in FIGS. 6 to 9 are displayed on the display 16 during the special game.

The display controller 141 executes a control for displaying a prescribed image on the upper display 33. Specifically, the CPU 106 generates an image display command according to the prescribed image and transmits the image display command to the display controller 141 via the I/O bus 104. On receiving the image display command output from the CPU 106, the display controller 141 generates a drive command for driving the upper display 33 based on the image display command and then outputs the generated drive command to the upper display 33. As a result, the prescribed image is displayed on the upper display 33. This image display can be done by a still image or a movie image.

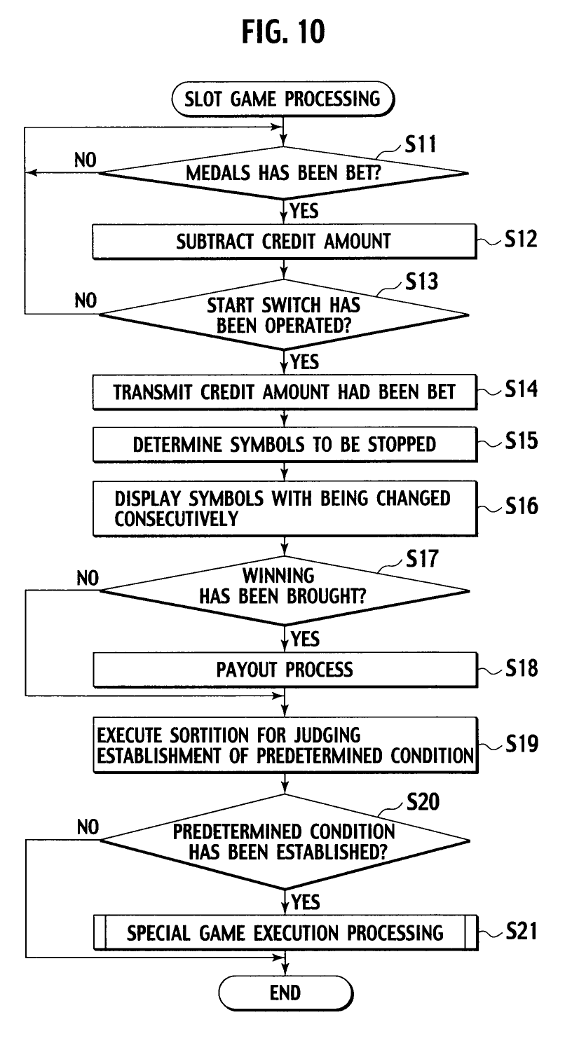

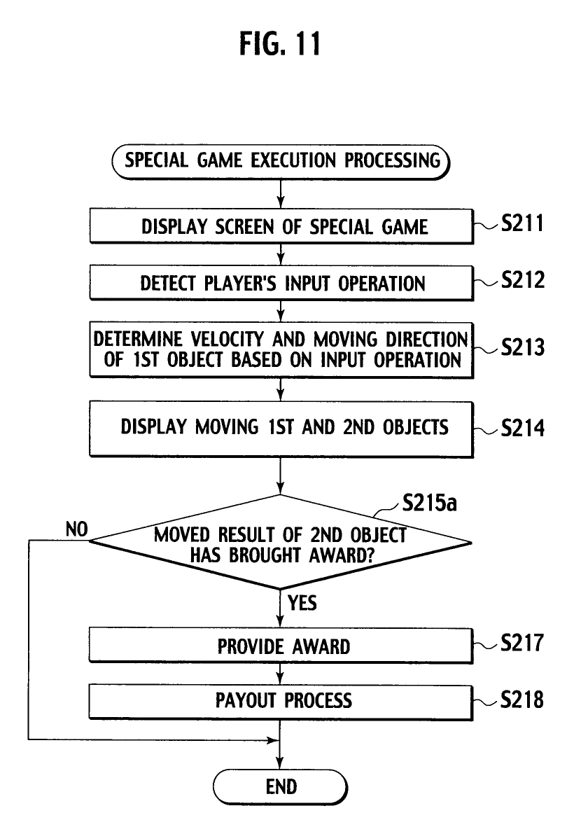

Next, operations of the slot machine 10 in the present embodiment will be explained with reference to flow charts shown in FIGS. 10 and 11. FIGS. 10 and 11 are flow charts showing procedures of the slot game processing and the special game processing executed by the CPU 106 shown in FIG. 5 according to the game execution programs stored in the ROM 108.

First, on entering the slot game processing shown in FIG. 10, the CPU 106 determines whether or not credits have been bet in step S11. In this process, the CPU 106 determines whether or not a signal output from the bet switch 25 on the bet switch 25 being pressed or a signal output from the max-bet switch 24 on the max-bet switch 24 being pressed has been received. If it is determined that credits have not been bet, the process flow returned to step S11.

On the other hand, if it is determined that credits have been bet in step S11, the CPU 106 proceeds to step S12 to subtract a credit amount had been bet from credits stored in the RAM 11.

Next, in step S13, the CPU 106 determines whether or not the start switch 27 has been pressed. In this process, the CPU 106 determines whether or not to receive the signal output from the start switch 27 on the start switch 27 being pressed.

If it is determined that the start switch 27 has not been pressed, the CPU 106 returns the process flow to step S11. Note that, in case where the start switch 27 has not been pressed (for example, a terminating command of game play has been input without the start switch 27 being pressed), the CPU 106 cancels the subtracting result of the credit amount.

Then, in step S13, if it is determined that the start switch 27 has been pressed, the CPU 106 shifts from step S13 to step S14 and transmits the credit amount had been bet to a payout controller 3. Parallel to this, in step S15, the CPU 106 determines symbols to be stopped. In this stop symbol determination process, the CPU 106 determines symbols to be displayed (rearranged) in the segmented areas q11 to q53 by executing a stop symbol determination program which is one of the game execution programs stored in the ROM 108.

By this stop symbol determination process, each symbol to be rearranged in the segmented areas q11 to q53 shown in FIG. 5 is determined as one of the nine kinds of symbols such as “A (Ace of cards)”, “K (King of cards)”, “Q (Queen of cards)”, “J (Jack of cards)”, “10 (Ten of cards)” “Umbrella”, “Lighting”, “Cloud” and “Special (male face).

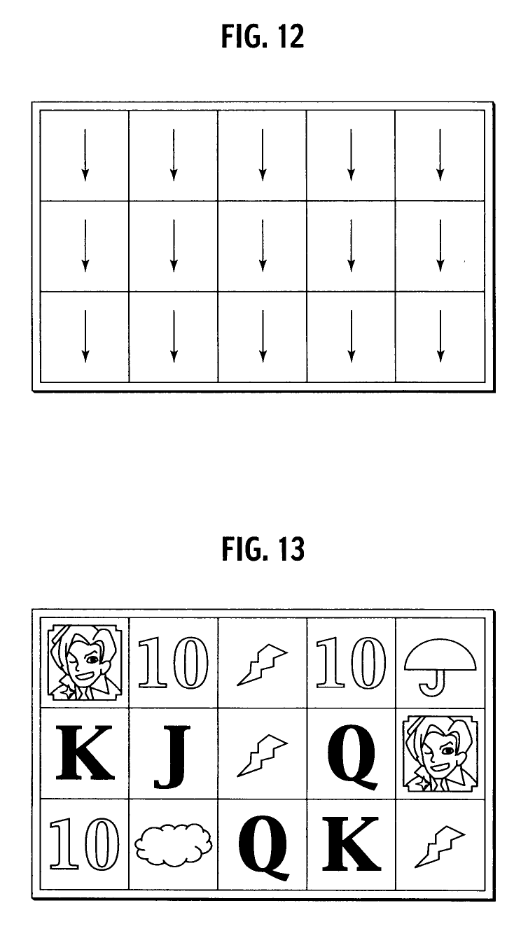

Next, in step S16, the CPU 106 executes symbol changing display process. This process is a process in which symbols are started to be displayed with being changed consecutively in the segmented areas q11 to q53 as shown in FIG. 12 and then the symbols are stopped in the segmented areas q11 to q53 as shown in FIG. 13. By this start and stop process of changing display, symbols are rearranged in the segmented areas q11 to q53.

Upon a termination of the symbol changing display process, the CPU 106 shifts to step S17 and determines whether or not a winning has been achieved based on the symbols rearranged in the segmented areas q11 to q53. Specifically, the CPU 106 determines whether or not a condition for providing an award has been met.

In this step S17, the CPU 106 determines whether or not the symbol combination rearranged in the above-mentioned step S16 matches with any one of the rearranged symbol combinations defined as eligibles for providing a payout in the payout table with reference to the payout table stored in the ROM 108

Then, if it matches with the rearranged symbol combination defined in the payout table, the payout amount corresponding to the rearranged symbol combination is determined as a credit payout for an achievement of a winning and the process flow shifts from step S17 to step S18.

On the other hand, if the symbol combination rearranged in the above-mentioned step S17 does not match with any one of the rearranged symbol combinations defined as eligibles for providing a payout in the payout table, the CPU 106 shifts the process to after-mentioned step S19 without an achievement of a winning.

In step S18, the CPU 106 executes a payout process for paying out credits according to a winning result in the above-mentioned step S16. In this payout process, the CPU 106 accumulates the credit payout amount in the above-mentioned step S17 into the credit amount stored in the RAM 111.

In step S19, the CPU 106 executes a sortition to determine whether or not the predetermined condition for a start of free games using a random number generated by the RNG 112. Then, in step S20, the CPU 106 determines whether or not the sortition result indicates an establishment of the predetermined condition.

If the sortition result does not indicate an establishment of the predetermined condition (indicates non-establishment) (NO in step S20), the CPU 106 returns to the above-mentioned step S11 to execute the next slot game processing. If the sortition result indicates an establishment of the predetermined condition (YES in step S20), the CPU 106 executes a special game execution processing in step S21 and then returns to the above-mentioned step S11 to execute the next slot game processing.

Within the special game execution processing of step S21, the CPU 106 determines screen display contents of the special game to be displayed on the display 16 from the plurality of arrangement patterns stored the external memory unit 113 in step 211 as shown in FIG. 11. And then, the CPU 106 generates an image display command of the determined arrangement pattern to display the special game on the display 16 (step S211) Next, the CPU 106 detects a player's input operation by the sensor 17 such as a touchpad (step S212). The CPU 106 stores data on an input distance and an input duration time taken from the input operation detected by the sensor 17 into the RAM 110, the external memory unit 113 and so on.

And then, the CPU 106 determines one from the plurality of movement patterns stored in the external memory unit 113 based on the data on the input distance and the input duration time taken from the input operation detected by the sensor 17 (step S213). The velocity and the moving direction of the first object 50 on the display 16 are determined due to the determination of the movement pattern by the CPU 106.

Subsequently, the CPU 106 generates a moving presentation command for the first object 50 to be moved according to the velocity and the moving direction determined in step S213 to display a moving presentation of the first object 50 on the display 16. Further, the CPU 106 generates moving presentation commands for the second objects 51a to 51c to be moved due to contacts with the first object 50 to display a moving presentation of the second objects 51a to 51c on the display 16 (step S214).

And then, the CPU 106 determines whether or not the moved results of the second objects 51a to 51c after the moving presentation have brought a result to provide an award to a player (step S215a). In this process, for example, the CPU 106 determines whether or not to receive a signal indicating an existence of any of the second objects 51a to 51c within any of the payout spots 53a and 53b.

If any of the moved results of the second objects 51a to 51c have not brought a result to provide an award to a player (NO in step S215a), the CPU 106 terminates the series of processes of the special game.

On the other hand, if any of the moved results of the second objects 51a to 51c have brought a result to provide an award to a player (YES in step S215a), the CPU 106 provides an award to the player for an award winning (step S217). And then, the CPU 106 executes a payout process for paying out credits corresponding to a payout amount set for an award to be provided (step S218). Subsequently, the special game execution processing is terminated.

As described above, in the present embodiment, the CPU 106 constitutes a controller in the claims.

According to the slot machine 10 as configured above, since the moved results of the first object 50 and the second objects 51a to 51c are varied in a special game according to a player's input operation, it is varied according to the player's input operation whether a payout process is executed for an award winning in a special game.

Therefore, according to the slot machine 10 in the present embodiment, since it is not preliminarily determined whether or not an award winning is to be brought, a payout and effects can be varied according to player's skill and judgment. Namely, an award can be varied according to a player's ability or skill.

Note that, in step S211 of FIG. 11, the arrangement patterns used for displaying the special game on the display 16 may be implemented in a program in the ROM 108 instead of being stored in the external memory unit 113

In addition, in step S213 of FIG. 11, the movement patterns used for determining the velocity and the moving direction of the first object 50 may be implemented in a program in the ROM 108 instead of being stored in the external memory unit 113.

### Second Embodiment

Next, a slot machine 10 and a playing method thereof according to a second embodiment of the present invention will be explained. Since it has substantively the same configuration as those of the slot machine 10 in the first embodiment, redundant explanations will be omitted.

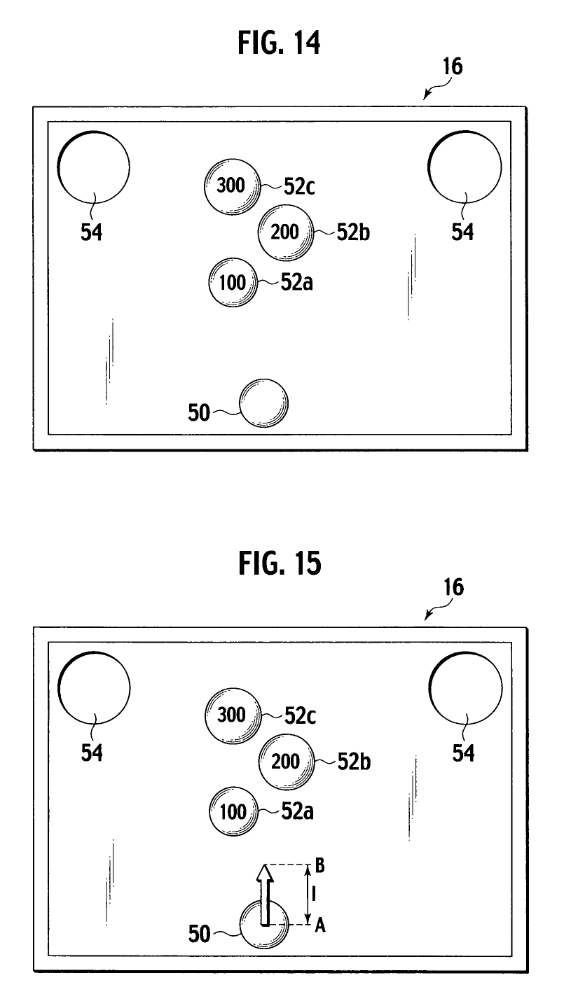

FIG. 1B is a flow chart showing a general scheme of the playing method of a gaming machine according to the second embodiment of the present invention. FIGS. 14 to 17 are explanatory diagrams showing screen examples displayed as a special game in the gaming machine according to the second embodiment of the present invention.

As shown in FIG. 1B, the slot machine 10 according to the second embodiment of the present invention displays a unit game on the display 16, in which symbols having been arranged are rearranged (step S1).

Next, as shown in FIG. 1B, the slot machine 10 determines whether or not the predetermined condition for a special game execution has been met (step S2).

Then, as shown in FIG. 1B, if the predetermined condition has not been met (NO in step S2), the slot machine 10 stops a series of processes and displays a unit game on the display again in step S1.

On the other hand, if the predetermined condition has been met (YES in step S2), the slot machine 10 displays a special game screen as shown in FIG. 14 on the display 16 (step S3). Here, each of the second objects 52a to 52c has an indication to provide an award corresponding to 100, 200 or 300 credits.

Subsequently, the slot machine 10 detects a player's input operation by a sensor 17 (see FIG. 59 such as a touchpad.

Next, the slot machine 10 determines velocity and a moving direction of the first object on the display 16 based on an input distance and an input duration time determined from the detected player's input operation (step S5).

For example, if the player's input operation as the arrow shown in FIG. 15 has been detected, input velocity l/t is calculated from the input distance l from an input start point A to an input end point B and the input duration time t spent for the input operation and the moving speed of the first object 50 on the display 16 is determined according to the calculated input velocity. In addition, the direction of the arrow connecting between the input start point A and the input end point B is determined as the moving direction of the first object 50 on the display 16.

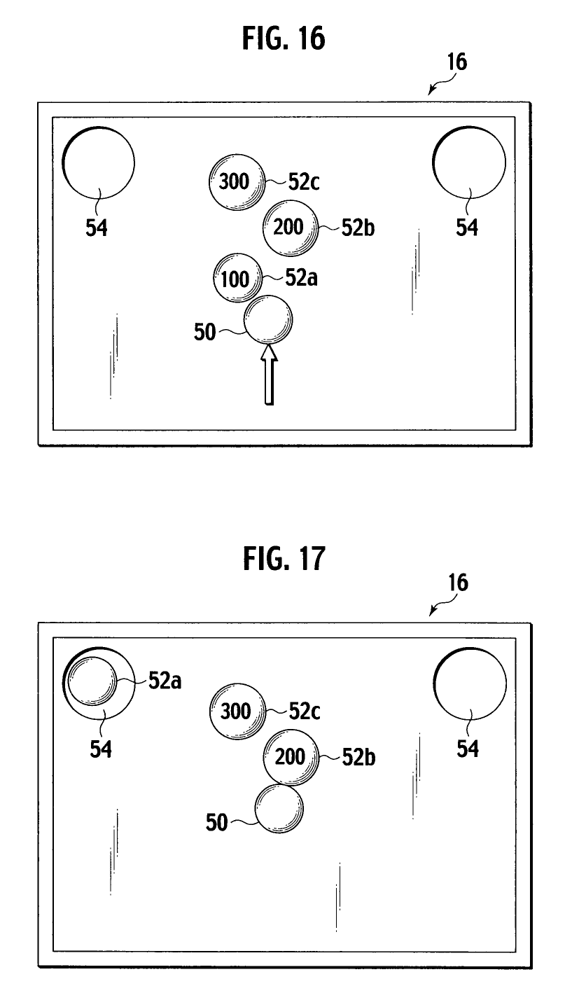

And then, as shown in FIG. 16, a moving presentation of the first object 50, which is being moved according to the velocity and the moving direction determined in step 5, is displayed on the display 16 (step S6). Further, as shown in FIG. 17, each moving presentation of the second objects 52a to 52c moved due to contacts with the first object 50 is displayed on the display 16 (step S6).

Here, it is determined whether or not moved results of the second objects 52a to 52c have brought a result to provide an award to a player (step S7b). For example, whether or not to bring a result to provide an award can be determined according to whether or not any of the moved results of the second objects 52a to 52c have brought a drop into any of the payout spots 54.

If any of the moved results of the second objects 52a to 52c have not brought a drop into any of the payout spots 54 (NO in step S7b), the slot machine 10 terminates the series of processes of the special game. On the other hand, as shown in FIG. 17, if any of the moved results of the second objects 52a to 52c have brought a drop into any of the payout spots 54 (YES in step S7b), an award is provided to a player (step S9).

As a result of the above-mentioned processes, in the slot machine 10 according to the second embodiment, the first object 50 is moved based on a player's input operation and whether to provide an award to a player is determined by judging whether or not any of the second objects 51a to 51c moved due to contacts with the first object 50 has brought a drop into any of the payout spots 54. In other words, the slot machine 10 according to the second embodiment can determine an award to be provided to a player in a special game based on a player's input operation. Therefore, a payout and effects can be varied according to player's skill and judgment and an award can be varied according to a player's ability or skill.

Next, with respect to the details of the slot machine according to the second embodiment of the present invention, different configurations from those in the slot machine according to the first embodiment will be explained.

The external memory unit 113 stores relations between the drop results into the payout spots 54 of the second objects 51a to 51c and awards to be provided to a player with respect to a game executed as the special game after the establishment of the predetermined condition.

In addition, the external memory unit 113 stores a plurality of arrangement patterns for determining arrangements of the first object 50, the second objects 52a to 52c and the payout spots 54 on the display 16 in the special game.

In addition, the external memory unit 113 stores a plurality of movement patterns to be selected based on a player's input operation for determining velocity and a moving direction of the first object 50.

The display controller 140 executes a display process to display the first object 50, the second objects 52a to 52c and the payout spots 54 on the display 16 during the special game as shown in FIGS. 14 to 17. Specifically, the CPU 106 generates an image display command for displaying images as shown in FIGS. 14 to 17 and outputs the image display command to the display controller 140 via the I/O bus 104 during the special game. On receiving the image display command output from the CPU 106, the display controller 140 generates a drive command for driving the display 16 based on the image display command and then outputs the generated drive command to the display 16. As a result, the images as shown in FIGS. 14 to 17 are displayed on the display 16 during the special game.

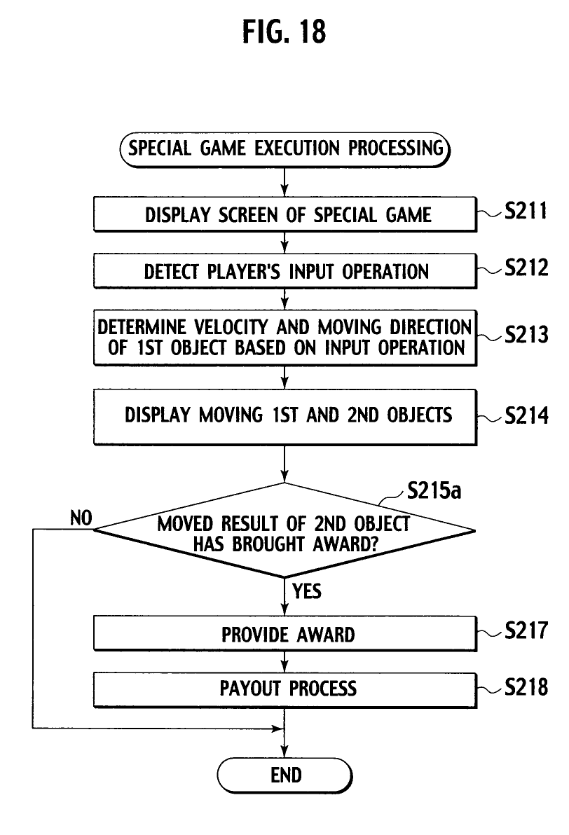

Next, operations of the slot machine 10 in the present embodiment will be explained with reference to flow charts shown in FIGS. 10 and 18. FIGS. 10 and 18 are flow charts showing procedures of the slot game processing and the special game processing executed by the CPU 106 shown in FIG. 5 according to the game execution programs stored in the ROM 108. However, since the slot game processing shown in 10 is substantially identical to that in the first embodiment, redundant explanations will be omitted.

Within the special game execution processing of step S21 shown in FIG. 10, the CPU 106 determines screen display contents of the special game to be displayed on the display 16 from the plurality of arrangement patterns stored the external memory unit 113 in step 211 as shown in FIG. 18. And then, the CPU 106 generates an image display command of the determined arrangement pattern to display the special game on the display 16 (step S211)

Next, the CPU 106 detects a player's input operation by the sensor 17 such as a touchpad (step S212). The CPU 106 stores data on an input distance and an input duration time taken from the input operation detected by the sensor 17 into the RAM 110, the external memory unit 113 and so on.

And then, the CPU 106 determines one from the plurality of movement patterns stored in the external memory unit 113 based on the data on the input distance and the input duration time taken from the input operation detected by the sensor 17 (step S213). The velocity and the moving direction of the first object 50 on the display 16 are determined due to the determination of the movement pattern by the CPU 106.

Subsequently, the CPU 106 generates a moving presentation command for the first object 50 to be moved according to the velocity and the moving direction determined in step S213 to display a moving presentation of the first object 50 on the display 16. Further, the CPU 106 generates moving presentation commands for the second objects 52a to 52c to be moved due to contacts with the first object 50 to display a moving presentation of the second objects 52a to 52c on the display 16 (step S214).

And then, the CPU 106 determines whether or not the moved results of the second objects 52a to 52c after the moving presentation have brought a result to provide an award to a player (step S215a). In this process, for example, the CPU 106 determines whether or not to receive a signal indicating a drop of any of the second objects 52a to 52c into any of the payout spots 54.

If any of the moved results of the second objects 52a to 52c have not brought a result to provide an award to a player (NO in step S215a), the CPU 106 terminates the series of processes of the special game.

On the other hand, if any of the moved results of the second objects 51a to 51c have brought a result to provide an award to a player (YES in step S215a), the CPU 106 provides an award to the player (step S217). And then, the CPU 106 executes a payout process for paying out credits corresponding to a payout amount set for an award to be provided (step S218). Subsequently, the special game execution processing is terminated.

As described above, in the present embodiment, the CPU 106 constitutes a controller in the claims.

According to the slot machine 10 as configured above, since the moved results of the first object 50 and the second objects 52a to 52c are varied in a special game according to a player's input operation, it is varied according to the player's input operation whether a payout process is executed for an award winning in a special game.

Therefore, according to the slot machine 10 in the present embodiment, since it is not preliminarily determined whether or not an award winning is to be brought, a payout and effects can be varied according to player's skill and judgment. Namely, an award can be varied according to a player's ability or skill.

### Third Embodiment

Next, a slot machine 10 and a playing method thereof according to a third embodiment of the present invention will be explained. Since it has substantively the same configuration as those of the slot machine 10 in the first embodiment, redundant explanations will be omitted.

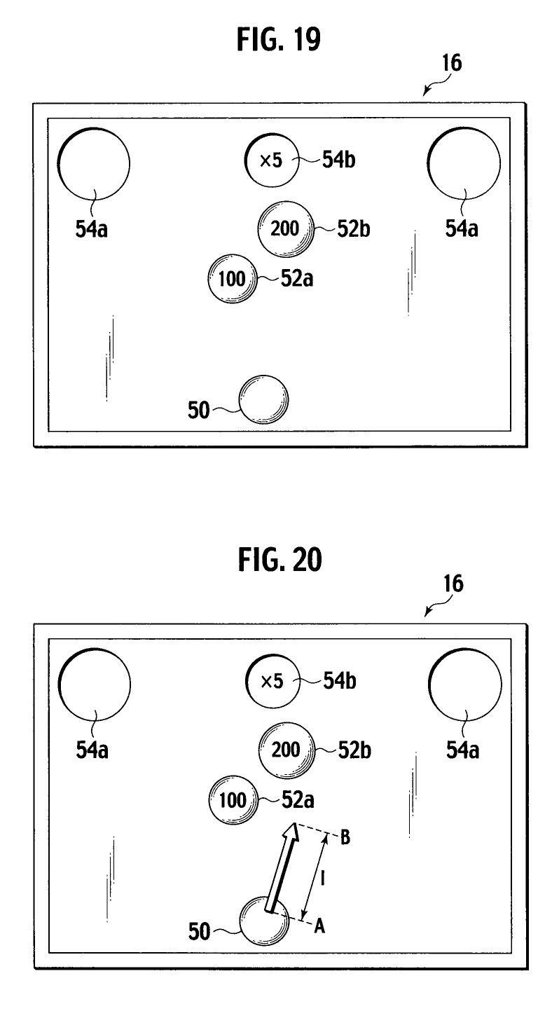

FIG. 1C is a flow chart showing a general scheme of the playing method of a gaming machine according to the third embodiment of the present invention. FIGS. 19 to 22 are explanatory diagrams showing screen examples displayed as a special game in the gaming machine according to the third embodiment of the present invention.

As shown in FIG. 1C, the slot machine 10 according to the third embodiment of the present invention displays a unit game on the display 16, in which symbols having been arranged are rearranged (step S1).

Next, as shown in FIG. 1C, the slot machine 10 determines whether or not the predetermined condition for a special game execution has been met (step S2).

Then, as shown in FIG. 1C, if the predetermined condition has not been met (NO in step S2), the slot machine 10 stops a series of processes and displays a unit game on the display again in step S1.

On the other hand, if the predetermined condition has been met (YES in step S2), the slot machine 10 displays a special game screen as shown in FIG. 14 on the display 16 (step S3). Here, each of the second objects 52a and 52b has an indication to provide an award corresponding to 100 or 200 credits. Each of payout spots 54a is a normal spot and a payout spot 54b is a multi spot. On the second objects 52a and 52b dropping thereinto, each of the payout spots 54a as the normal spots will be bring an award corresponding to the indication on the second objects 52a and 52b. On the other hand, the payout spot 54b as the multi spot will be bring an award with being varied its payout rate due to being differentiated from an award for dropping into the normal spot. For example, as shown in FIG. 19, the payout spot 54b has an indication “×5” and will brings an awards as five times much as an award for dropping into the normal spot. In other words, if any of the second objects 52a and 52b drops into the payout spot 54b, an award as five times much as the indication on the second objects 52a and 52b will be brought.

Subsequently, the slot machine 10 detects a player's input operation by a sensor 17 (see FIG. 59 such as a touchpad.

Next, the slot machine 10 determines velocity and a moving direction of the first object on the display 16 based on an input distance and an input duration time determined from the detected player's input operation (step S5).

For example, if the player's input operation as the arrow shown in FIG. 20 has been detected, input velocity l/t is calculated from the input distance l from an input start point A to an input end point B and the input duration time t spent for the input operation and the moving speed of the first object 50 on the display 16 is determined according to the calculated input velocity. In addition, the direction of the arrow connecting between the input start point A and the input end point B is determined as the moving direction of the first object 50 on the display 16.

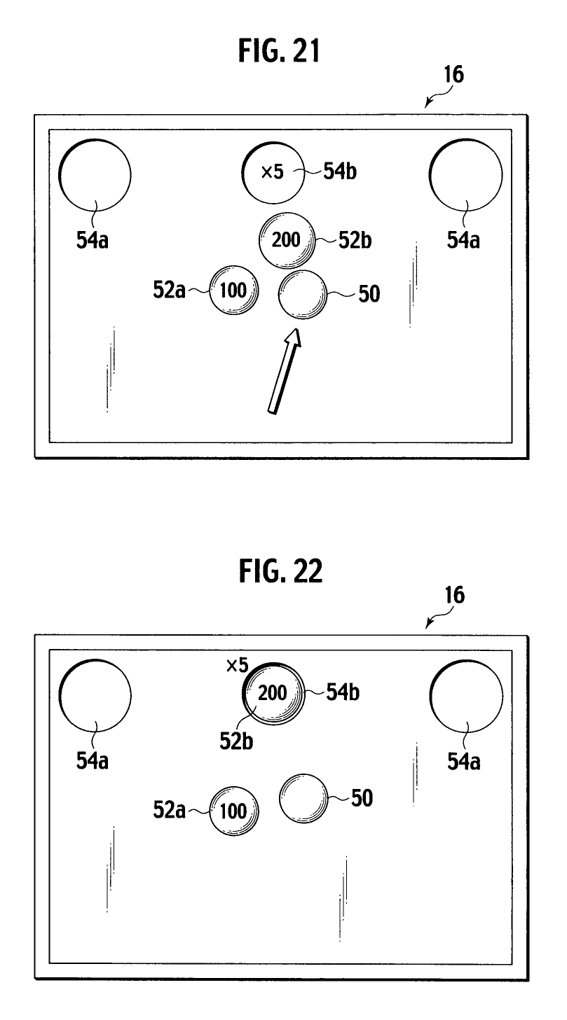

And then, as shown in FIG. 21, a moving presentation of the first object 50, which is being moved according to the velocity and the moving direction determined in step S5, is displayed on the display 16 (step S6). Further, as shown in FIG. 22, each moving presentation of the second objects 52a and 52b moved due to contacts with the first object 50 is displayed on the display 16 (step S6).

Here, it is determined whether or not moved results of the second objects 52a and 52b have brought a result to provide an award to a player (step S7b). For example, whether or not to bring a result to provide an award can be determined according to whether or not any of the moved results of the second objects 52a and 52b have brought a drop into any of the payout spots 54a and 54b.

If any of the moved results of the second objects 52a and 52b have not brought a drop into any of the payout spots 54a and 54b (NO in step S7b), the slot machine 10 terminates the series of processes of the special game. On the other hand, as shown in FIG. 22, if any of the moved results of the second objects 52a and 52b have brought a drop into any of the payout spots 54a and 54b (YES in step S7b) and also the payout spot 54b, into which any of the second objects 52a and 52b has dropped, is the multi spot, a payout rate for an award is changed (step S8). And then, an award corresponding to the payout spots 54a and 54b is provided to a player (step S9).

As a result of the above-mentioned processes, in the slot machine 10 according to the third embodiment, the first object 50 is moved based on a player's input operation and whether to provide an award to a player is determined by judging whether or not any of the second objects 52a to 52c moved due to contacts with the first object 50 has brought a drop into any of the payout spots 54a and 54b. And then, when any of the second objects 52a to 52c has dropped into the multi spot such as the payout spot 54b, the slot machine 10 can increase an award to be provided to the player. In other words, the slot machine 10 according to the third embodiment can determine an award amount to be provided to a player in a special game based on a player's input operation. Therefore, a payout and effects can be varied according to player's skill and judgment and an award can be varied according to a player's ability or skill.

Next, with respect to the details of the slot machine according to the third embodiment of the present invention, different configurations from those in the slot machine according to the first embodiment will be explained.

The external memory unit 113 stores relations between the drop results into the payout spots 54a and 54b of the second objects 52a and 52b and awards to be provided to a player with respect to a game executed as the special game after the establishment of the predetermined condition.

In addition, the external memory unit 113 stores a plurality of arrangement patterns for determining arrangements of the first object 50, the second objects 52a and 52b and the payout spots 54a and 54b on the display 16 in the special game.

In addition, the external memory unit 113 stores a plurality of movement patterns to be selected based on a player's input operation for determining velocity and a moving direction of the first object 50.

The display controller 140 executes a display process to display the first object 50, the second objects 52a and 52b and the payout spots 54a and 54b on the display 16 during the special game as shown in FIGS. 19 to 22. Specifically, the CPU 106 generates an image display command for displaying images as shown in FIGS. 19 to 22 and outputs the image display command to the display controller 140 via the I/O bus 104 during the special game. On receiving the image display command output from the CPU 106, the display controller 140 generates a drive command for driving the display 16 based on the image display command and then outputs the generated drive command to the display 16. As a result, the images as shown in FIGS. 19 to 22 are displayed on the display 16 during the special game.

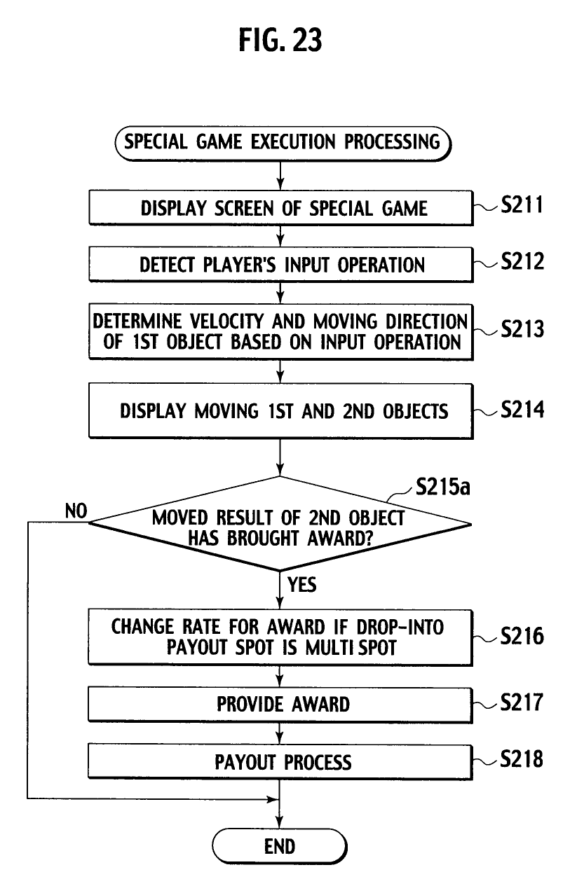

Next, operations of the slot machine 10 in the present embodiment will be explained with reference to flow charts shown in FIGS. 10 and 23. FIGS. 10 and 23 are flow charts showing procedures of the slot game processing and the special game processing executed by the CPU 106 shown in FIG. 5 according to the game execution programs stored in the ROM 108. However, since the slot game processing shown in 10 is substantially identical to that in the first embodiment, redundant explanations will be omitted.

Within the special game execution processing of step S21 shown in FIG. 10, the CPU 106 determines screen display contents of the special game to be displayed on the display 16 from the plurality of arrangement patterns stored the external memory unit 113 in step 211 as shown in FIG. 23. And then, the CPU 106 generates an image display command of the determined arrangement pattern to display the special game on the display 16 (step S211) Next, the CPU 106 detects a player's input operation by the sensor 17 such as a touchpad (step S212). The CPU 106 stores data on an input distance and an input duration time taken from the input operation detected by the sensor 17 into the RAM 110, the external memory unit 113 and so on.

And then, the CPU 106 determines one from the plurality of movement patterns stored in the external memory unit 113 based on the data on the input distance and the input duration time taken from the input operation detected by the sensor 17 (step S213). The velocity and the moving direction of the first object 50 on the display 16 are determined due to the determination of the movement pattern by the CPU 106.

Subsequently, the CPU 106 generates a moving presentation command for the first object 50 to be moved according to the velocity and the moving direction determined in step S213 to display a moving presentation of the first object 50 on the display 16. Further, the CPU 106 generates moving presentation commands for the second objects 52a and 52b to be moved due to contacts with the first object 50 to display a moving presentation of the second objects 52a and 52b on the display 16 (step S214).

And then, the CPU 106 determines whether or not the moved results of the second objects 52a and 52b after the moving presentation have brought a result to provide an award to a player (step S215a). In this process, for example, the CPU 106 determines whether or not to receive a signal indicating a drop of any of the second objects 52a and 52b into any of the payout spots 54a and 54b.

If any of the moved results of the second objects 52a and 52b have not brought a result to provide an award to a player (NO in step S215a), the CPU 106 terminates the series of processes of the special game.

On the other hand, if any of the moved results of the second objects 52a and 52b have brought a result to provide an award to a player (YES in step S215a) and also the payout spot 54b, into which any of the second objects 52a and 52b has dropped, is the multi spot, the CPU 106 changes a payout rate of an award (step S216). Subsequently, the CPU 106 provides an award corresponding to the payout spots 54a and 54b to the player (step S217). And then, the CPU 106 executes a payout process for paying out credits corresponding to a payout amount set for an award to be provided (step S218). Subsequently, the special game execution processing is terminated.

As described above, in the present embodiment, the CPU 106 constitutes a controller in the claims.

According to the slot machine 10 as configured above, since the moved results of the first object 50 and the second objects 52a and 52b are varied in a special game according to a player's input operation, it is varied according to the player's input operation whether a payout process is executed for an award winning in a special game. In addition, when the second object has dropped into the multi spot such as the payout spot 54b, the slot machine 10 can increase an award to be provided to the player. In other words, the slot machine 10 according to the third embodiment can determine an award amount to be provided to a player in a special game based on a player's input operation.

Therefore, according to the slot machine 10 in the present embodiment, since it is not preliminarily determined whether or not an award winning is to be brought, a payout and effects can be varied according to player's skill and judgment. Namely, an award can be varied according to a player's ability or skill.

### Fourth Embodiment

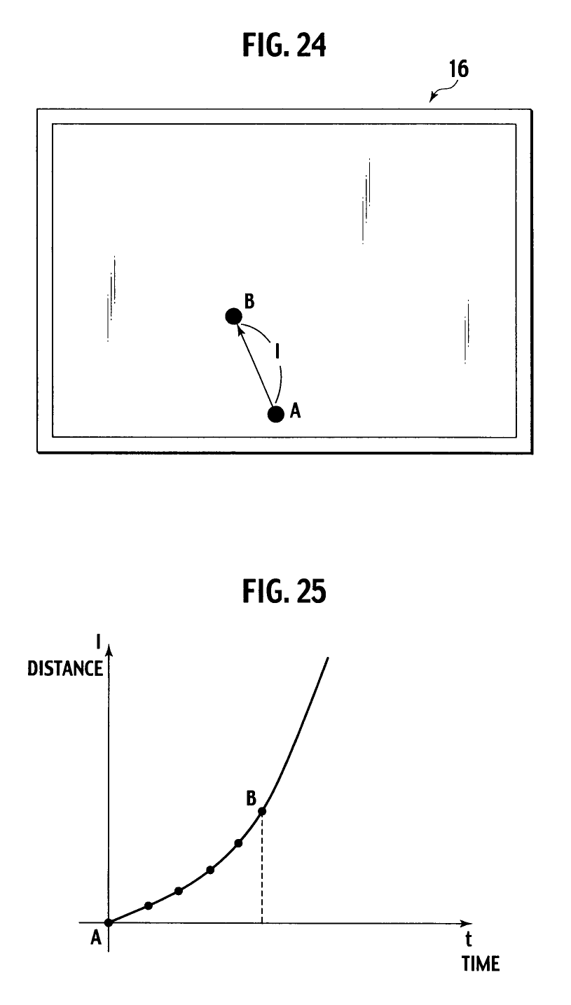

Next, a slot machine 10 and a playing method thereof according to a fourth embodiment of the present invention will be explained with reference to FIGS. 24 and 25. Since it has substantively the same configuration as those of the slot machine 10 in the first embodiment, redundant explanations will be omitted.

In the slot machine according to the fourth embodiment, contents of the determination process of the velocity and the moving direction of the first object 50 executed by the CPU 106 are partially different from contents of the special game execution processing in the first embodiment shown in FIG. 10.

First, in the slot machine of the forth embodiment, within the special game execution processing of step S21 shown in FIG. 10, the CPU 106 detects a player's input operation by the sensor 17 such as a touchpad (step S212) as shown in FIGS. 11, 18 and 23. For example, the player's input operation between the input start point A and the input end point B is detected per a predetermined unit time as shown in FIG. 24. The sensor 17 detects moving distances per the predetermined unit time between the input start point A and the input end point B and generates a graph on relations between time and distance of the input operation as shown in FIG. 25 based on the detected moving distances per the predetermined unit time. The generated graph is stored in the RAM 110, the external memory unit 113 and so on.

Next, the CPU 106 determines the velocity and the moving direction of the first object 50 on the display 16 based on the data on the input distance and the input duration time taken from the input operation detected by the sensor 17 (step S213). Here, the CPU 106 determines the direction of the arrow connecting between the input start point A and the input end point B as the moving direction of the first object 50 on the display 16 as shown in FIG. 24. And then, the CPU 106 calculates a derivative value at the input end point B to acquire velocity at the point B based on the graph on relations between time and distance of the input operation. The CPU 106 determines the velocity of the first object 50 on the display 16 according to the velocity at the point B.

According to the slot machine and the playing method thereof in the fourth embodiment, the same advantages can be achieved as those according to the slot machines 10 and the playing method thereof in the first to third embodiments.

### Other Embodiments

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

For example, although the first object 50 is operated only once in the special game in the first to fourth embodiments, it may be operated twice or more times.

Further, although a slot machine is explained as a gaming machine in the first to fourth embodiments, it may be a card game machine.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A gaming machine executing a unit game and a special game, comprising:
a display for displaying, upon establishment of a predetermined condition in the unit game, the special game in which a first object is operated so as to contact with a second object in order to move the second object;
a sensor for detecting a player's input operation onto the display to operate the first object; and
a controller programmed to execute following processing (A) and (B):
(A) a process for determining, in the special game, velocity and a moving direction of the first object on the display based on an input distance and an input duration time taken from the input operation detected by the sensor, and
(B) a process for determining an award to be provided to the player based on a moved result of the second object moved due to a contact with the first object having been moved according to the determined velocity and the determined moving direction.

2. The gaming machine according to claim 1, wherein
the process for determining the velocity and the moving direction of the first object includes following processes:
a process for determining the velocity of the first object according to an operating velocity at an end point of the input operation detected by the sensor, and
a process for determining the moving direction of the first object according to a direction from a start point to the end point of the input operation detected by the sensor.

3. The gaming machine according to claim 1, wherein
the sensor is a touchscreen for detecting the input operation on the display.

4. The gaming machine according to claim 1, wherein
the display displays the second object on which a payout amount is indicated.

5. A gaming machine executing a unit game and a special game, comprising:
a display for displaying, upon establishment of a predetermined condition in the unit game, the special game in which a first object is operated so as to contact with a second object in order to drop the second object into a payout spot;
a sensor for detecting a player's input operation onto the display to operate the first object; and
a controller programmed to execute following processing (A) and (B):
(A) a process for determining, in the special game, velocity and a moving direction of the first object on the display based on an input distance and an input duration time taken from the input operation detected by the sensor, and
(B) a process for determining an award to be provided to the player based on a result of dropping into the payout spot of the second object moved due to a contact with the first object having been moved according to the determined velocity and the determined moving direction.

6. The gaming machine according to claim 5, wherein
the process for determining the velocity and the moving direction of the first object includes following processes:
a process for determining the velocity of the first object according to an operating velocity at an end point of the input operation detected by the sensor, and
a process for determining the moving direction of the first object according to a direction from a start point to the end point of the input operation detected by the sensor.

7. The gaming machine according to claim 5, wherein
the sensor is a touchscreen for detecting the input operation on the display.

8. The gaming machine according to claim 1, wherein
the display displays the second object on which a payout amount is indicated.

9. A gaming machine executing a unit game and a special game, comprising:
a display for displaying, upon establishment of a predetermined condition in the unit game, the special game in which a first object is operated so as to contact with a second object in order to drop the second object into payout spots including a multi spot to which a different payout rate is set;
a sensor for detecting a player's input operation onto the display to operate the first object; and
a controller programmed to execute following processing (A) and (B):
(A) a process for determining, in the special game, velocity and a moving direction of the first object on the display based on an input distance and an input duration time taken from the input operation detected by the sensor, and
(B) a process for determining an award to be provided to the player based on a result of dropping into the payout spots of the second object moved due to a contact with the first object having been moved according to the determined velocity and the determined moving direction.

10. The gaming machine according to claim 9, wherein
the process for determining the velocity and the moving direction of the first object includes following processes:
a process for determining the velocity of the first object according to an operating velocity at an end point of the input operation detected by the sensor, and
a process for determining the moving direction of the first object according to a direction from a start point to the end point of the input operation detected by the sensor.

11. The gaming machine according to claim 9, wherein
the sensor is a touchscreen for detecting the input operation on the display.

12. The gaming machine according to claim 9, wherein
the display displays the second object on which a payout amount is indicated.

13. A control method of a gaming machine that includes a display for displaying, upon establishment of a predetermined condition in a unit game, a special game in which a first object is operated so as to contact with a second object in order to move the second object, and a sensor for detecting a player's input operation onto the display to operate the first object, the method comprising:
executing a process for determining, in the special game, velocity and a moving direction of the first object on the display based on an input distance and an input duration time taken from the input operation detected by the sensor, and
executing a process for determining an award to be provided to the player based on a moved result of the second object moved due to a contact with the first object having been moved according to the determined velocity and the determined moving direction.

14. The control method of a gaming machine according to claim 13, wherein
the process for determining the velocity and the moving direction of the first object includes following processes:
a process for determining the velocity of the first object according to an operating velocity at an end point of the input operation detected by the sensor, and
a process for determining the moving direction of the first object according to a direction from a start point to the end point of the input operation detected by the sensor.

15. The control method of a gaming machine according to claim 13, wherein
the sensor is a touchscreen for detecting the input operation on the display.

16. The control method of a gaming machine according to claim 13, wherein
the display displays the second object on which a payout amount is indicated.
